(19) United States
(12) Patent Application Publication
(10) Pub. No.: US 2009/0096411 A1
(43) Pub. Date: Apr. 16, 2009

(54) Charging Stand

(76) Inventors: Anssi Vanska, Helsinki (FI); Antti Virolainen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/087,910

(22) PCT Filed: Jan. 16, 2006
(86) PCT No.: PCT/IB2006/000060

§ 371 Date: Nov. 12, 2008

(51) Int. Cl. H02J 7/00

(52) U.S. Cl. 320/107

(57) ABSTRACT

A charging stand 10 for an electronic device 20 with at least one motion sensor 22, 23 comprises a charging interface 13 arranged to enable a charging of an electronic device 20. In order to enable an extended use of the charger stand 10 and of the electronic device 20, the charger stand 10 further comprises at least one fastening element 12 adapted to detachably fasten an electronic device 20 to the charging stand 10 and adapted to enable a tilting of a fastened electronic device 20 to produce motions for detection by at least one motion sensor 22, 23 of the fastened electronic device 10. A corresponding system may comprise both the charging stand 10 and the electronic device 20.

### FIELD OF THE INVENTION

The invention relates to a charging stand for an electronic device. The invention relates equally to a system comprising such a charging stand.

### BACKGROUND OF THE INVENTION

A handheld electronic device may be provided with motion sensors, which allow tracking a movement of the electronic device by a user. The tracked movement can then be used for instance for controlling an application, like a game or a monitoring system. Such an application can be implemented within the electronic device. Alternatively, it can also be implemented in a separate computing device. In the latter case, the electronic device can be used as a controller for the computing device, for instance as a game pad for a game console. For enabling an additional control, the electronic device may further be provide with user input means, like buttons or keys.

If the electronic device is to be used as a controller for a separate computing device, it has to comprise a data transfer component for transmitting control data to the computing device. The data transfer component can be an interface for a wired connection or an interface for a wireless connection, like a radio connection, a Bluetooth™ connection, an infrared connection, etc.

It is a problem of such a handheld electronic device that its handling is not optimal for a control of all kinds of applications. For instance, with flight games, the gaming experience is usually better with traditional joystick devices compared to a handheld game pad.

### SUMMARY OF THE INVENTION

It is an object of the invention to enhance the usability of an electronic device having motion sensors.

A charging stand for an electronic device with at least one motion sensor is proposed. The charging stand comprises a charging interface arranged to enable a charging of an electronic device. The charging stand further comprises at least one fastening element adapted to detachably fasten an electronic device to the charging stand and adapted to enable a tilting of a fastened electronic device to produce motions for detection by at least one motion sensor of the fastened electronic device.

Moreover, a system is proposed, which comprises such a charging stand and an electronic device with at least one motion sensor.

The invention proceeds from the consideration that a handheld electronic device usually comprises a rechargeable battery. The invention proceeds further from the consideration that a charger stand can be used for recharging the battery in a convenient manner. The invention is based on the idea that such a charger stand and an electronic device can be used in combination for enabling a controlled movement of the electronic device. It is therefore proposed that a charger stand is designed such that an electronic device can be detachably connected to it in a manner which allows at least a tilting of the electronic device.

It is an advantage of the invention that the charging stand gives stable ground for a detachable electronic device and that it allows producing accurate movements of the electronic device, which can be detected by a motion sensor of the electronic device. A conventional charging stand is thus made more versatile. It can be used for charging the electronic device, for keeping the electronic device when it is not in use and in addition as a part of a joystick-like assembly. At the same time, the detachable design enables a flexible use of the electronic device, either as a handheld electronic device or as a part of a joystick-like assembly.

The charging stand may enable further movements of a fastened electronic device than tilting, for example a rotation of a fastened electronic device that can be detected by at least one motion sensor of the fastened electronic device.

In one embodiment of the invention, the fastening element of the charging stand is arranged to provide a mechanical feedback to the enabled movements, for example to a tilting of a fastened electronic device and/or to a rotation of a fastened electronic device.

A mechanical feedback can be achieved in many different ways. It may be implemented in the charging stand for example in the form of a viscose feedback, that is, the faster a user tries to tilt the joystick, the more the joystick resists the movement. It may also be implemented for example by means of at least one spring, to achieve a traditional click sound and force feedback. Further, it may be implemented for example in the form of an active feedback by means of a motor, etc.

In one embodiment of the invention, the charging stand itself comprises a charger component realizing the functions of a charger, that is, a charger component adapted to charge the battery of an electronic device. In this case, the charging stand may be connected directly to a wall outlet. In an alternative embodiment, the charging stand may comprise only an interface to a conventional charger that is adapted to charge the battery of an electronic device.

The electronic device can be for example a controller for a computing device providing game functions or monitoring functions, etc. Alternatively or in addition, the electronic device may use the detected motion for a control of functions provided by the electronic device itself.

The charging stand does not have to be provided with any intelligence, as the removable electronic device comprises the motion sensors and as all the intelligence may be added in the removable electronic device. It is to be understood, however, that also the charging stand could be provided with processing, communication and haptic feedback functions, etc., if desired.

The at least one motion sensor of the electronic device may be selected as required or desired. It may comprise for example an accelerometer that is adapted to detect translatory movements in up to three dimensions, an angular acceleration sensor, a magnetometer, a gyro sensor, a compass, for instance a compass comprising a 3-axis magnetometer, etc.

In addition to the motion sensors, the electronic device may comprise various other components, including for instance user input means like buttons or keys, which may be employed by a user for entering commands.

The proposed system may further comprise a computing device adapted to be controlled by the electronic device, in particular based the detected movement and possibly based on a user input via further user input means. In this case, the electronic device should comprise in addition a data transfer component adapted to transfer the required data to the computing device.

The connection enabled by such a data transfer component may be a wired connection or a wireless connection. A wireless connection may be for instance a Bluetooth™ connection, an infrared connection or a Wireless Local Area Network (WLAN) connection, etc.

The charging stand does not require any connection to such a computing device.

Advantageously, the electronic device is handle shaped, in order to enable a convenient handling of the electronic device by the user.

### BRIEF DESCRIPTION OF THE FIGURES

Other objects and features of the present invention will become apparent from the following detailed description considered in conjunction with the accompanying drawings.

FIG. 1 is a schematic block diagram of a system according to an embodiment of the invention;

FIG. 2 is a diagram illustrating the fastening of an electronic device to a charging stand;

FIG. 3 is a diagram illustrating the enabled swinging of an electronic device fastened to a charging stand; and

FIG. 4 is a block diagram of a further enhanced charging stand.

### DETAILED DESCRIPTION OF THE INVENTION

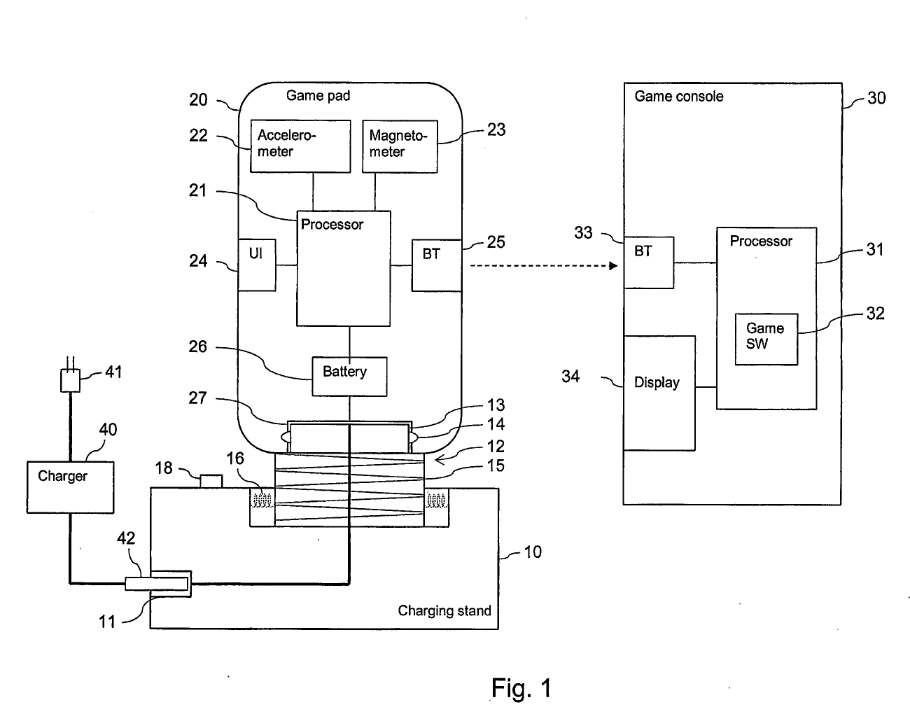

FIG. 1 is a schematic block diagram of a system according to an exemplary embodiment of the invention.

The system comprises a charging stand 10, a game pad 20 as an exemplary electronic device, a game console 30 as an exemplary computing device and a charger 40.

The charger 40 can be a conventional charger that may be connected on the one hand via a first plug 41 to a wall outlet, and on the other hand via a second plug 42 to an electronic device or to the charging stand 10.

The charging stand 10 comprises a socket 11 for receiving the second plug 42 of the charger 40. The charging stand 10 further comprises a fastening element 12 for enabling a fastening of a game pad 20. The fastening element includes an upper portion 13 and a lower main portion 15.

The upper portion 13 is made of a rigid material and adapted to interact with the game pad 20 for fixing the game pad 20 detachably to the charging stand 10. FIG. 1 presents by way of example movable, protruding locking elements 14 that are attached to the upper portion 13 and that enable a snap-on connection for fixing the game pad 20 to the charging stand 10. The charging stand 10 comprises a button 18 for releasing the connection between the upper portion 13 and the game pad 20. In the example of FIG. 1, the protruding locking elements 14 could be retrieved to this end by activating the button 18. For reasons of clarity, the details of this mechanism are not shown in FIG. 1. Moreover, it is to be understood that various other mechanisms can be employed as well for fixing a game pad 20 to a fastening element 12. The upper portion 13 of FIG. 1 further provides an electrical contact to a charging interface of a fastened game pad 20.

The main portion 15 of the fastening element 12 is made of a flexible material that can be tilted in all directions. It could comprise to this end, for instance, a spring or flexible plastics. It has to be noted, however, that the presented embodiment is only intended to illustrate the principle of the fastening element 12. Alternatively, it could also be made for example of a rigid material, which is borne such that it may swing to all sides, possibly restrained by springs providing another type of mechanical feedback. A possible arrangement of such springs 16 is illustrated in FIG. 1 by dotted lines. In addition, the main portion 15 of the fastening element 12 is connected to the charging stand 10 such that it can be rotated around its vertical axis.

The socket 11 is electrically connected to the electrical contact of the upper portion 13 of the fastening element 12.

It is to be understood that the presented charging stand 10 may comprise various other components not shown. The charging stand 10 could be provided for example with a vibration component or a force feedback component and with communication means adapted to cause a vibration or a force feedback based on received commands.

The game pad 20 has the form of a handle. It comprises a microprocessor 21 and, connected to this microprocessor 21, an accelerometer 22, a magnetometer 23, a user input 24, a Bluetooth™ (BT) component 25 and a battery 26. The battery 26 provides a supply voltage to the microprocessor 21 and to any other component of the game pad 20 requiring a supply voltage. The user input may comprise for instance buttons, keys and/or a small joystick for a thumb. At its bottom, the game pad 20 comprises a recess 27, including a charging interface, adapted to interact with the upper part 13 of the fastening element 12 of the charging stand 10 for fastening the game pad 20 at the charging stand 10. The battery 26 is connected to the charging interface at the recess 27. It is to be understood that the game pad 20 may comprise various other components not shown, like a memory for storing application software that can be executed by the microprocessor 21, a vibrating component, a force feedback component, a mobile phone component, etc.

The game console 30 comprises a processor 31 that is adapted to execute installed application software 32. A Bluetooth™ (BT) interface 33 and a display 34 are connected to the processor 31. It is to be understood that the game console may comprise various other components, like a memory for storing application software, an interface for receiving a memory for storing such application software, a user input, loudspeakers, etc.

A user may wish to play a game that is activated on the game console 30. Depending on the type of the game, the user may prefer using a handheld game pad or a joystick for controlling the game.

For controlling the game by means of a handheld game pad, the user simply uses the game pad 20 by itself. All movements of the game 20 pad are detected by the sensors 22, 23, and corresponding signals are provided to the microprocessor 21. The microprocessor 21 calculates 3D gestures corresponding to the received signals and transmits information on the detected gestures via the BT interface 25 to the game console 30. The game console 30 receives the information via its own BT interface 33 and processes the information in the processor 31 for controlling the ongoing game. The processing may result for instance in movements of presented objects or persons on the display 34 and in accompanying sounds via loudspeakers. It is to be noted that alternatively, the microprocessor 21 could simply forward the received sensor signals to the game console 30. In this case, the processor 31 of the game console 30 has to take care of all processing. This approach requires the transmission of a larger amount of data, though.

In addition, the user may initiate an action in the ongoing game, for instance by pressing a button belonging to the user interface 24, etc. Corresponding signals are forwarded via the microprocessor 21 and the BT interface 25 to the game console 30 as well. The game console 30 receives the signals via its BT interface 33 and processes the information in the processor 31 in order to cause corresponding action, including a presentation of the action on the display 34.

It is to be understood that some games may be controlled exclusively by user inputs via the user interface 24. Further, the game console 30 could be enabled to provide a feedback to the game pad 20 via the BT interfaces 33, 25, for instance for controlling a vibration or a force feedback enabled by the game pad 20.

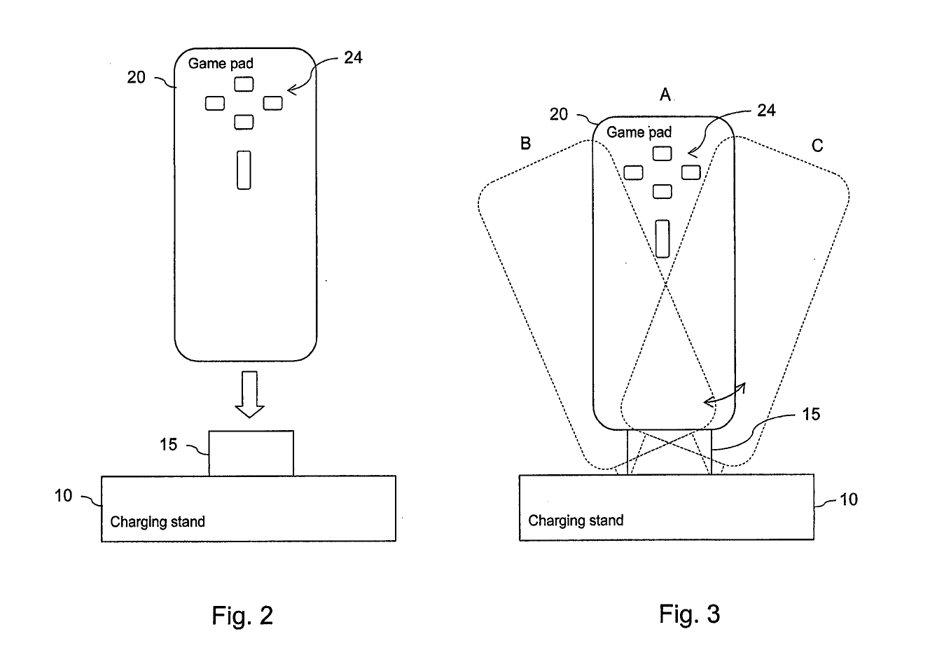

For controlling the game by means of a joystick, in contrast, the user fastens the game pad 20 to the charging stand 10. This is illustrated in FIG. 2. FIG. 2 is a schematic diagram of a charger stand 10 and a game pad 20. By way of example, the game pad 20 comprises four buttons and a toggle switch as a user interface 24. Another option could be to provide the game pad 20 with a small joystick for a thumb and a toggle switch as a user interface 24, etc. In the presented situation, the game pad 20 is not yet fastened to the charger stand 10, but held by the user directly above the charger stand 10. For fastening the game pad 20 to the charger stand 10, the user simply has to lower the game pad 20 onto the fastening element 12 of the charging stand 10, in order to cause the recess 27 of the game pad 20 to engage with the upper portion 13 of the fastening element 12. Advantageously, the user has to release some locking component for detaching the game pad 20 again. Thereby, it can be ensured that the game pad 20 is fixed securely to the charging stand 10, even when the user moves the game pad 20 for controlling a game.

As the fastening element 12 is arranged such that it may be tilted and rotated, the user may also tilt and rotate the game pad 20 when it is fastened to the charging stand 10. This is illustrated in FIG. 3. FIG. 3 is a schematic diagram illustrating three different tilting positions of the game pad 20 when connected to the charger stand 10. Solid lines are used for indicating a rest position A of the game pad 20 and the fastening element 12. Dashed lines are used for indicating a tilting to the left B and a tilting to the right C. Similarly, the game pad 20 can be tilted backwards and forwards. Finally, the game pad 20 can be rotated around its vertical axis, as indicated in FIG. 3 by an arrow.

The fixing and the mechanical feedback improve the handling of the game pad 20 for some applications. The combination of charging stand 10 and game pad 20 can be handled by the user in a familiar way just like a conventional joystick.

Also in this case, all movements of the game pad 20 are detected by the sensors 22, 23 and corresponding signals are provided to the microprocessor 21. The processing of the sensor signals and of signals generated by a user input via the user interface 24 can be the same as in the case of a handheld game pad 20 described above. Due to the fixing to the charging stand 10, the movements of the game pad 20 will be more accurate than when being hold in the hands of the user, though.

For charging the battery 26 of the game pad 20, the game pad 20 is fastened in the same way to the charger stand 10 as described above with reference to FIG. 2. Thereby, the charging interface of the game pad 20 is coupled to the electrical contact of the upper portion 13 of the fastening element 12 of the charging stand 10.

For the use of the charging stand 10 as a part of a joystick, the charging stand 10 does not have to be connected to the charger 40. For charging the battery 26 of the game pad 20, a charger 40 has to be connected between a wall outlet and the socket 11 of the charging stand 10.

It has to be noted that it would also be possible to provide two differently designed game pads 20 that can be combined with a respective charger stand 10, one for each hand. The first game pad could comprise for instance action buttons for one thumb, while the other game pad could comprise for instance a small joystick for the other thumb.

The invention thus enables a flexible use of a game pad and an extended use of a charging stand.

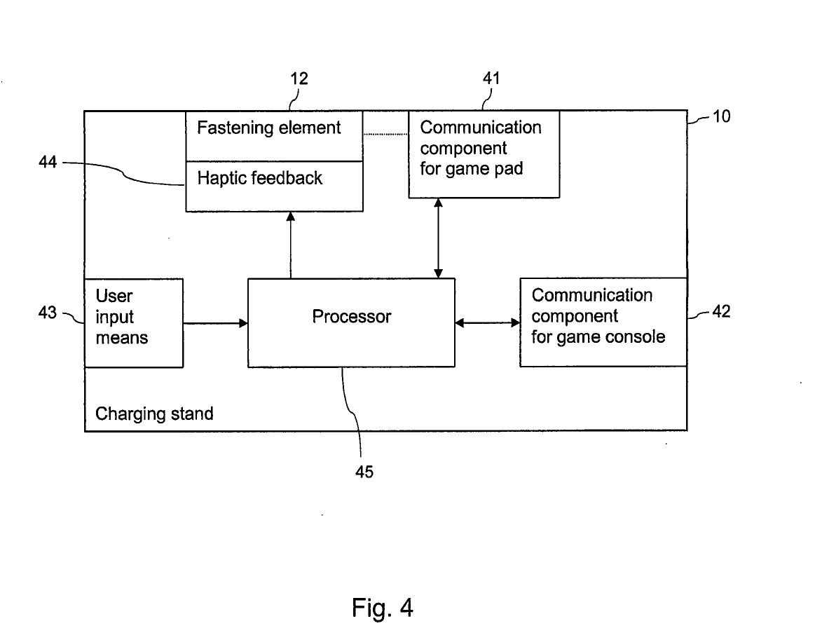

As indicated above, the presented charging stand 10 may comprise various other components not shown. For illustration, FIG. 4 is a block diagram of an enhanced charging stand 10.

The charging stand 10 comprises again a fastening element 12 for connecting a game pad 20. Further, it comprises again conventional charging means, which are not shown in FIG. 4.

Moreover, the charging stand 10 may comprise a communication component 41 that supports a unidirectional or a bi-directional signal exchange with the game pad 20. The communication component 41 may provide for instance an electrical connection, an Infrared interface, a Bluetooth™ interface, etc., for a communication with a connected game pad 20. It is to be understood that the game pad 20 has to comprise a corresponding communication component for enabling a signal exchange. An electrical connection could be created for example automatically via the fastening element 12 when fastening the game pad 20 to the charging stand 10. Alternatively or in addition, the charging stand 10 may comprise a communication component 42 that supports a unidirectional or bi-directional signal exchange with the game console 30. The communication component 42 may provide for instance an interface for a wired connection, an Infrared interface, a Bluetooth™ interface, etc., for a communication with the game console 30. It is to be understood that the game console 30 has to comprise a corresponding communication component for enabling a signal exchange.

The charging stand 10 may further comprise user input means 43, including for instance buttons etc.

The charging stand 10 may further comprise haptic feedback means 44 that can act on the fastening element 12 for providing a haptic feedback to a user using a connected game pad 20. The feedback can be for instance a vibration or a forced feedback.

The charging stand 10 may further comprise a processor 45 that is linked to the communication components 41, 42, to the user input means 43 and to the haptic feedback means 44.

The processor 45 may process all signals that are received by the charging stand 10 via a communication component 41, 42 or via the user input means 43. It may, for instance, forward a user-input via the user input means 43 to the game pad 20 or directly to the game console 30 using the corresponding communication component 41, 42. Further, it may adjust settings of the haptic feedback means 44 based on a user input via the user input means 43. Further, it may cause the haptic feedback means 44 to provide a haptic feedback to a user based on some command received from the game pad 20 or directly from the game console 30 via the respective communication component 41, 42, etc.

It is to be noted that the described embodiments constitute only some of a variety of possible embodiments of the invention.

1. Charging stand for an electronic device with at least one motion sensor, said charging stand comprising:
a charging interface arranged to enable a charging of an electronic device; and
at least one fastening element adapted to detachably fasten an electronic device to said charging stand and adapted to enable a tilting of a fastened electronic device to produce motions for detection by at least one motion sensor of said fastened electronic device.

2. Charging stand according to claim 1, wherein said fastening element is further adapted to enable a rotation of a fastened electronic device to produce motions for detection by at least one motion sensor of said fastened electronic device.

3. Charging stand according to claim 1, wherein said fastening element is arranged to provide a mechanical feedback to at least one of a tilting of a fastened electronic device and a rotation of a fastened electronic device.

4. Charging stand according to claim 1, further comprising at least one communication component adapted to enable a communication with at least one electronic device.

5. Charging stand according to claim 4, further comprising haptic feedback means adapted to cause a haptic feedback to a fastened electronic device upon a corresponding command received via said at least one communication component.

6. Charging stand according to claim 1, further comprising user input means adapted to enable a user input relating to a use of said charging stand in combination with a moved fastened electronic device.

7. Charging stand according to claim 1, further comprising a processor adapted to process signals relating to a use of said charging stand in combination with a moved fastened electronic device.

8. Charging stand according to claim 1, wherein said charging stand comprises at least one of a charging component adapted to charge a battery of an electrical device and an interface for connecting a charger adapted to charge a battery of an electrical device.

9. Charging stand according to claim 1, wherein said electronic device is a controller for a computing device.

10. System comprising a charging device and an electronic device, said electronic device comprising at least one motion sensor and said charging stand comprising:
a charging interface arranged to enable a charging of said electronic device; and
at least one fastening element adapted to detachably fasten said electronic device to said charging stand and adapted to enable a tilting of said fastened electronic device to produce motions for detection by said at least one motion sensor of said fastened electronic device.

11. System according to claim 10, wherein said at least one motion sensor of said electronic device comprises at least one of an accelerometer, a magnetometer, a gyro sensor, a compass and an angular acceleration sensor.

12. System according to claim 10, wherein said electronic device further comprises user input means.

13. System according to claim 10, further comprising a computing device adapted to be controlled by said electronic device.

14. System according to claim 10, wherein said electronic device further comprises a data transfer component adapted to transfer data to a computing device.

15. System according to claim 10, wherein said electronic device is handle shaped.
